(19) United States
(12) Patent Application Publication
(10) Pub. No.: US 2019/0047050 A1
(43) Pub. Date: Feb. 14, 2019

(54) METHOD FOR COMPOSITE ADDITIVE MANUFACTURING WITH DUAL-LASER BEAMS FOR LASER MELTING AND LASER SHOCK

(71) Applicant: GUANGDONG UNIVERSITY OF TECHNOLOGY, GUANGZHOU (CN)

(72) Inventors: Yongkang ZHANG, GUANGZHOU (CN); Zheng ZHANG, GUANGZHOU (CN); Lei GUAN, GUANGZHOU (CN); Qingtian YANG, GUANGZHOU (CN); Zhifan YANG, GUANGZHOU (CN)

(21) Appl. No.: 16/153,711

(22) Filed: Oct. 6, 2018

Related U.S. Application Data
(63) Continuation of application No. PCT/CN2017/092076, filed on Jul. 6, 2017.

(30) Foreign Application Priority Data
Jun. 5, 2017 (CN) 201710413348.7

(51) Int. Cl. B22F 3/105; C21D 10/00; B29C 64/153; C23C 24/10

(52) U.S. Cl. CPC B22F 3/1055; C21D 10/005; B33Y 10/00; C23C 24/103; B29C 64/153

(57) ABSTRACT

A method for composite additive manufacturing with dual-laser beams for laser melting and laser shock, includes the following steps: 1) performing cladding on metal powder through a first continuous laser beam by thermal effect, and performing synchronous shock forging on material in a cladding region through a second short-pulse laser beam by shock wave mechanical effect, so as to perform the composite additive manufacturing; and 2) stacking the material in the cladding region layer by layer to form a workpiece. The method has the characteristics that the two laser beams make full use of the thermal effect and the shock wave mechanical effect, and synchronously work in a coupled manner, so that defects such as pores, incomplete fusion and shrinkage in a cladding layer are eliminated, and the performance of the workpiece is obviously improved. The method is high in manufacturing efficiency.

### CROSS-REFERENCE TO RELATED APPLICATIONS

This application is a continuation of International Patent Application No. PCT/CN2017/092076 with a filing date of Jul. 6, 2017, designating the United States, now pending, and further claims priority to Chinese Patent Application No. 201710413348.7 with a filing date of Jun. 5, 2017. The content of the aforementioned applications, including any intervening amendments thereto, are incorporated herein by reference.

### TECHNICAL FIELD

The present disclosure relates to the technical field of additive manufacturing, and particularly to a method for composite additive manufacturing with dual-laser beams for laser melting and laser shock.

### BACKGROUND OF THE PRESENT INVENTION

Additive manufacturing, different from traditional “removing” manufacturing, directly produces objects of any shapes through a material adding method according to computer graphic data without an original blank and a mold, and is an important development direction of the advanced manufacturing technology.

An existing pure laser cladding 3D forming process is actually a “free additive forming” process, and generally has the following common technical problems: (1) internal defects: various special internal metallurgical defects, such as pores, incomplete fusion, cracks and shrinkage, may generated in partial regions inside parts due to process parameters, an external environment, fluctuation and change of a state of a melt in a molten pool, transformation of a scanning and filling track and the like. These internal defects are fatal fatigue sources for load-bearing structural members, and may affect the internal quality and the mechanical property of finally formed parts and the service and use safety of the structural members. Organizational features shown by additive-manufactured metal materials have certain differences from conventional cast, forged and welded metals. These organizational features are bad for the metal materials in many cases. For example, a microscopic structure formed by performing selective laser melting on a nickel-based alloy Inconel1718 generates a texture phenomenon, and segregation of elements Nb and Mo still exists in a v-based solid solution. (2) Thermal stress and deformation cracking: 3D printing forming is a continuous circulating process of “point-by-point scanning and melting, line-by-line scanning and overlapping and layer-by-layer solidification and stacking”, and different parts of the cross section of a part have different heat transfer efficiencies, so that a core material is cooled relatively slowly, and a surface material is cooled relatively fast. In a non-balanced solid-state phase change process under rapid solidification and shrinkage, cyclic heating and non-uniform cooling of a moving molten pool under such strong confinements, complicated thermal stress, structural stress and stress concentration and deformation may be generated in the part, seriously affecting the geometrical size and the mechanical property of the part and resulting in serious warping deformation and cracking of the part.

Therefore, how to avoid the problems of the pores, incomplete fusion and shrinkage as much as possible during manufacturing of metal parts through metal material adding is a technical problem to be urgently solved by those skilled in the art. Chinese patent No. CN103862050 A provides a metal 3D printer and printing method based on layer-to-layer shock strengthening process. The special point of this Chinese patent is that 3D printing forming is stopped after a certain number of layers are cladded at each time; then an upper surface of a cladding layer is heated to 100° C. to 700° C. through a heating device; and laser shock strengthening or mechanical peening strengthening is performed on the cladding layer. This method is a combination of three procedures, namely cladding, heating and strengthening. Heating and strengthening are post-treatment processes, instead of composite manufacturing, for the cladding layer. Process parameters of the three procedures are selected independently, and do not affect each other, so that the three procedures are implemented independently. This method has the following problems that: (1) the cladding layer is subjected to the laser shock strengthening after cooled, and has a small plastic deformation, so that the internal defects such as pores, shrinkage and micro cracks inside the cladding layer are very hard to eliminate. (2) The complexity of the heating device of the cladding layer would be multiplied along with the increase in size and structural complexity of a clad part, and even it is hard to realize, so that a partial heating technology is higher in difficulty. It takes a very long time to heat a cooled large-sized 3D printing structural member to 700° C., and one heating cycle is conducted after multiple layers are cladded, so that the efficiency is extremely low. (3) Partial region peening strengthening is very hard to realize through mechanical peening, and shots for peening are very difficult to clean. Chinese patent No. 105935771 A provides a 3D printing laser micro-region treatment method for a metal mold. After layer-by-layer laser cladding deposition is adopted, the cladding layer is then subjected to secondary laser surface quenching treatment. By parity of reasoning, the metal mold is formed. The method includes two processes for forming the metal mold, so that the machining efficiency is low. Furthermore, through the laser surface quenching, it may only change the surface hardness of the part, and it is very hard to eliminate the internal defects of a cladding deposited layer. Repeated laser quenching enables internal stress to be higher, so that deformation and cracking are easier to occur.

The present disclosure proposes a composite additive manufacturing method with dual-laser beams for cladding forming and impact forging. Dual laser beams are simultaneously used for performing the composite additive manufacturing process. Namely, a first continuous laser beam performs cladding on metal powder by thermal effect, and a second short-pulse laser beam performs synchronous shock forging on material in a cladding region by shock wave mechanical effect, so as to perform the composite additive manufacturing, and the material in the cladding region are stacked layer by layer to form a workpiece. A significant difference between this method and the above-mentioned methods is that this method is a composite additive manufacturing process. The metal cladding process and the plastic shock forging process are performed in a metal cladding stage, so that the part machining efficiency is improved, the forming quality is guaranteed at the same time, and a contradiction between the manufacturing efficiency and the quality of metal cladding forming is effectively solved.

### SUMMARY OF PRESENT INVENTION

Aiming at the problems of pores, incomplete fusion and shrinkage in prior art, the present disclosure provides a method for composite additive manufacturing with dual-laser beams for laser melting and laser shock to improve the mechanical property and the fatigue strength of a metal part. The method includes the following steps: performing cladding on metal powder through a first continuous laser beam by thermal effect, and performing synchronous shock forging on material in a cladding region through a second short-pulse laser beam by shock wave mechanical effect, so as to perform the composite additive manufacturing; and stacking the material in the cladding region layer by layer to form a workpiece.

Preferably, the method further includes: conducting on-line monitoring and control, by a temperature sensor, to temperature in the cladding region of the first continuous laser beam according to different characteristics of machined metal materials, so as to enable the metal materials to be in a temperature range that is most favorable for plastic forming after the metal materials are cladded and then cooled, and performing the shock forging through the second short-pulse laser beam; and decreasing/increasing the temperature of the first continuous laser beam to form closed-loop control if the metal materials deviate from the temperature range that is most favorable for plastic forming after the metal materials are cladded and then cooled resulting from extreme high/low temperature of the first continuous laser beam.

Forging parameters of the second short-pulse laser beam are monitored and controlled by a light beam quality detector or apparatus. A pulse width of the second short-pulse laser beam is determined according to a thickness of the material in the cladding region, so that the material along a depth of the cladding region is fully and thoroughly forged. A forging frequency and a light spot size of the second short-pulse laser beam are determined according to an area of the material in the cladding region, so as to ensure that moving speed of laser shock forging is matched with a laser cladding speed and ensure that a temperature in a forging region is always in a temperature range that is most favorable for plastic deformation. The moving speed of the first continuous laser beam is reduced to form closed-loop control if the area/thickness of the material in the cladding region exceeds a preset limit of the second short-pulse laser beam, and vice versa.

Advantageously, a coaxial powder feeding amount is monitored and controlled by a powder feeder. The coaxial powder feeding amount determines the thickness and the area of the cladding region, and also affects the moving speed of the first continuous laser beam and the forging parameters of the second short-pulse laser beam. The moving speed of the first continuous laser beam is decreased/increased to form coupled control if the powder feeding amount exceeds/does not reach a preset amount of the first continuous laser beam.

Parameters of the composite additive manufacturing with dual-laser beams are detected and controlled online. The second short-pulse laser beam is capable of performing the shock forging on a front surface or side surface of a cladding layer at any angle between 15 to 165 degrees or in any position, has circular light spots and square light spots or randomly exchange therebetween, and is capable of treating cladding-formed parts having different structural characteristics.

According to the above, the method for composite additive manufacturing with dual-laser beams for laser melting and laser shock provided by the present disclosure breaks through the quality defects of the traditional metal cladding forming, also avoids shortcomings of secondary heating, thermal stress and reduction of the efficiency which are caused by a secondary strengthening process, and proposes a composite additive manufacturing process based on the laser thermal effect and the shock wave mechanical effect. When the metal powder melted by a heat source forms a cladding region, laser shock treatment is synchronously performed on the cladding region, so that the forming process and the strengthening process are completed in one manufacturing procedure, and outstanding features of high efficiency and high quality are achieved.

### DESCRIPTION OF THE DRAWINGS

In order to make the technical solutions in the disclosure or in the prior art described more clearly, the drawings associated to the description of the embodiments or the prior art will be illustrated concisely hereinafter. Obviously, the drawings described below are only some embodiments according to the disclosure. Numerous drawings therein will be apparent to one of ordinary skill in the art based on the drawings described in the disclosure without creative efforts.

FIG. 1 illustrates implementation steps of a method for composite additive manufacturing with dual-laser beams for laser melting and laser shock provided by the present disclosure; and

FIG. 2 is a microscopically structural schematic diagram of a cladding layer. In the figures: 1: cladding layer; 2: molten pool; 3: metal powder; 4: continuous laser; 5: short-pulse laser; 6: plasma; 7: shock wave; 8: defect such as pores, shrinkage and incomplete fusion; 9: fused metal crystal; and 10: variable angle of short-pulse laser.

### DETAILED DESCRIPTION OF PREFERRED EMBODIMENTS

In order to make the objects, technical solution and advantages of the present disclosure more clear, the present disclosure will be further described in detail with reference to the accompanying drawings and embodiments below. It should be understood that embodiments described here are only for explaining the present disclosure and the disclosure, however, should not be constructed as limited to the embodiment as set forth herein.

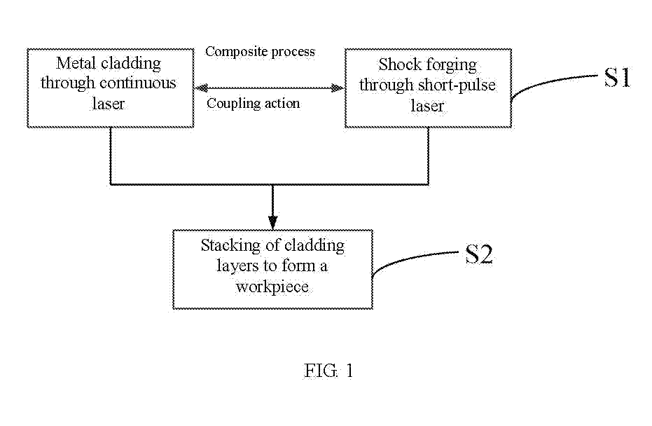

Referring to FIG. 1, FIG. 1 illustrates steps of a specific implementation mode provided by the present disclosure:

Step 1), performing cladding on metal powder through a first continuous laser beam by thermal effect, and performing synchronous shock forging on material in a cladding region through a second short-pulse laser beam by shock wave mechanical effect, so as to perform the composite additive manufacturing.

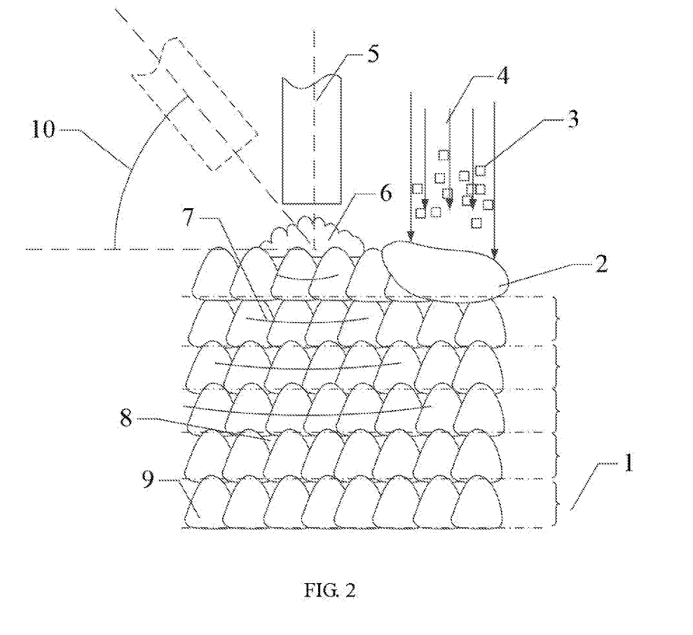

The step includes a process parameter detection and control process as follows, and as shown in FIG. 2.

The thermal effect of the first continuous laser beam 4 generates a molten pool 2 according to different characteristics of machined metal materials, and a temperature of the molten pool is monitored and controlled online through a temperature sensor, so as to enable the metal materials to be in a temperature range that is most favorable for plastic forming after the metal materials are cladded and then cooled. A second short-pulse laser beam 5 performs shocking to generate plasmas 6) and the plasmas 6 penetrate through a certain depth of a cladding layer 1 by means of shock waves. Under the action of a shock wave mechanical effect, defects 8 such as pores, shrinkage and incomplete fusion are closed, so as to achieve the aim of equivalent forging. Parameters are adjusted to decrease/increase the temperature of the first continuous laser beam molten pool 2 to form closed-loop control if the temperature of the molten pool 2 is extremely high/low and results in such a phenomenon that the clad and cooled materials deviate from the best plastic forming temperature range, namely under the action of the plasmas 6, the material temperature shall be in the best plastic forming temperature range.

Forging parameters of the second short-pulse laser beam 5 are monitored and controlled by a light beam quality detector or apparatus. A pulse width of the second short-pulse laser beam impact wave is determined according to a thickness of the material in the cladding region 1, so that a depth material of the whole cladding layer is fully and thoroughly forged. A forging frequency and a light spot size of the second short-pulse laser beam 5 are determined according to a material area in an acting region of the plasmas 6, so as to ensure that the moving speed of laser shock forging is matched with a laser cladding speed and ensure that a temperature in a forging region is always in a temperature range that is most favorable for plastic deformation. The moving speed of the first continuous laser beam 4 is reduced to form closed-loop control if the area/thickness of the material in the cladding region exceeds a preset limit of the second short-pulse laser beam 5, and vice versa.

In the method for composite additive manufacturing with dual-laser beams for laser melting and laser shock, a coaxial powder feeding amount is monitored and controlled by a powder feeder. The coaxial powder feeding amount determines a thickness and an area of the cladding region, and also affects moving speed of the first continuous laser beam 4 and forging parameters of the second short-pulse laser beam 5. The moving speed of the first continuous laser beam 4 is decreased/increased to form coupled control if the powder feeding amount exceeds/does not reach a preset amount of the first continuous laser beam 4.

Parameters of the composite additive manufacturing with dual-laser beams are detected and controlled online. The second short-pulse laser beam is capable of performing the shock forging on a front surface or side surface of a cladding layer at any angle between 15 to 165 degrees or in any position, has circular light spots and square light spots or randomly exchange therebetween, and is capable of treating cladding-formed parts having different structural characteristics.

Step 2), stacking the material in the cladding region layer by layer to form a workpiece. Since each layer of cladding-formed metal undergoes continuous laser thermal effect forming and short-pulse laser shock wave effect forging, the mechanical property is obviously improved, and the metal may reach a level of a forged part.

We claim:

1. A method for composite additive manufacturing with dual-laser beams for laser melting and laser shock, comprising the following steps:
performing cladding on metal powder through a first continuous laser beam by thermal effect, and performing synchronous shock forging on material in a cladding region through a second short-pulse laser beam by shock wave mechanical effect, so as to perform the composite additive manufacturing; and
stacking the material in the cladding region layer by layer to form a workpiece.

2. The method for composite additive manufacturing with dual-laser beams for laser melting and laser shock according to claim 1, wherein a temperature of the first continuous laser beam is monitored and controlled online through a temperature sensor according to different characteristics of machined metal materials, so as to enable the metal materials to be in a temperature range that is most favorable for plastic forming after the metal materials are cladded and then cooled, and the second short-pulse laser beam performs the shock forging; and the temperature of the first continuous laser beam is decreased/increased to form closed-loop control if the metal materials deviate from the temperature range that is most favorable for plastic forming after the metal materials are cladded and then cooled resulting from extreme high/low temperature of the first continuous laser beam.

3. The method for composite additive manufacturing with dual-laser beams for laser melting and laser shock according to claim 1, wherein forging parameters of the second short-pulse laser beam are monitored and controlled by a light beam quality detector or apparatus; a pulse width of the second short-pulse laser beam is determined according to a thickness of the material in the cladding region, so that the material along a depth of the cladding region is fully and thoroughly forged; a forging frequency and a light spot size of the second short-pulse laser beam are determined according to an area of the material in the cladding region, so as to ensure that moving speed of laser shock forging is matched with a laser cladding speed and ensure that a temperature in a forging region is always in a temperature range that is most favorable for plastic deformation; and the moving speed of the first continuous laser beam is reduced to form closed-loop control if the area/thickness of the material in the cladding region exceeds a preset limit of the second short-pulse laser beam, and vice versa.

4. The method for composite additive manufacturing with dual-laser beams for laser melting and laser shock according to claim 1, wherein a coaxial powder feeding amount is monitored and controlled by a powder feeder; the coaxial powder feeding amount determines a thickness and an area of the cladding region, and also affects moving speed of the first continuous laser beam and forging parameters of the second short-pulse laser beam; and the moving speed of the first continuous laser beam is decreased/increased to form coupled control if the powder feeding amount exceeds/does not reach a preset amount of the first continuous laser beam.

5. The method for composite additive manufacturing with dual-laser beams for laser melting and laser shock according to claim 1, wherein parameters of the composite additive manufacturing with dual-laser beams are detected and controlled online; the second short-pulse laser beam is capable of performing the shock forging on a front surface or side surface of a cladding layer at any angle between 15 to 165 degrees or in any position, has circular light spots and square light spots or randomly exchange therebetween, and is capable of treating cladding-formed parts having different structural characteristics.
